(19) United States
(12) Patent Application Publication
(10) Pub. No.: US 2016/0320198 A1
(43) Pub. Date: Nov. 3, 2016

(54) RIDE-SHARING ROUTING USING CONTEXTUAL CONSTRAINTS

(71) Applicant: Ford Global Technologies, LLC, Dearborn, MI (US)

(72) Inventors: Yimin Liu, Ann Arbor, MI (US); Perry Robinson MacNeille, Lathrup Village, MI (US); Jinjing Yang, Ypsilanti, MI (US)

(21) Appl. No.: 14/699,241

(22) Filed: Apr. 29, 2015

(51) Int. Cl. G01C 21/36

(52) U.S. Cl. CPC G01C 21/36; G01C 21/3608

(57) ABSTRACT

A computing device may receive an indication of a change in constraint data, the change altering a vehicle-external factor used to determine at least one of a time, cost, intermediate waypoint, origin, and destination constraint of an upcoming user route; determine an alternate route for the user in accordance with the constraint, as altered; and send an update to a mobile device of the user indicating the alternate route. A mobile device of a user may receive, from the user, a contextual constraint specifying an element of external constraint data to be tested and a value against which the element is to be tested; display, to the user, a route constructed satisfying the contextual constraint based on the external constraint data; and when the external constraint data is changed, display a received message indicating a proposed update to the route.

### TECHNICAL FIELD

Aspects of the disclosure generally relate to a multi-modal transportation system allowing for trip planning, bidding, displaying, and trip reservation, including the routing of ride-sharing users using contextual constraints.

### BACKGROUND

A multi-modal transportation system is a system in which goods or passengers may be transported using multiple modes of transportation. These modes of transportation may include, as some examples, buses, trains, airplanes, cars, bicycles, boats (e.g., ferries, cruise lines, etc.) and even walking, and may include travel over paths such as roads, rails, monorails, tunnels, water, and air. Multi-modal transportation systems may foster competition between transportation modes such as between mass transit, multi-individual transit, and individual transit. Which transportation mode becomes dominant may depend on cultural, financial, geographic, occupant, and resource constraints. Many urban areas include multi-modal transportation systems including a hybrid of mass and individual transit systems interconnected at transportation hubs.

### SUMMARY

In a first illustrative embodiment, a system includes a computing device configured to receive an indication of a change in constraint data, the change altering a vehicle-external factor used to determine at least one of a time, cost, intermediate waypoint, origin, and destination constraint of an upcoming user route; determine an alternate route for the user in accordance with the constraint, as altered; and send an update to a mobile device of the user indicating the alternate route.

In a second illustrative embodiment, a computer-implemented method includes receiving, from a user device, a contextual constraint specifying timing for a route according to an event external to a vehicle traversing the route; constructing the route using trip characteristics including an origin location and a destination location that satisfies the timing; and providing an updated route to the user device calculated in response to a received update in the timing of the event.

In a third illustrative embodiment, a system includes a mobile device of a user configured to receive, from the user, a contextual constraint specifying an element of external constraint data to be tested and a value against which the element is to be tested; display, to the user, a route constructed satisfying the contextual constraint based on the external constraint data; and in response to a change in the external constraint data, display a received message indicating a proposed update to the route.

### BRIEF DESCRIPTION OF THE DRAWINGS

FIG. 1 illustrates an example diagram including a vehicle configured to access telematics servers and a mobile device having a trip-planning application;

FIG. 2A illustrates an example logical diagram of a multi-modal transportation system;

FIG. 2B illustrates an example network diagram of the multi-modal transportation system;

FIG. 3 illustrates an example data diagram of characteristics useful for the generation of a route;

FIG. 4 illustrates an example data flow for constructing a route;

FIG. 5 illustrates an example data flow diagram for a constraint analyzer analyzing which routes satisfy specified constraints;

FIG. 6 illustrates an example user interface of the trip-planning application for specifying contextual constraints for a route;

FIG. 7 illustrates an example process for constructing a route; and

FIG. 8 illustrates an example process for automatically updating a route based on an indication of a change in external constraint data.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A multi-modal transportation system may be a system in which goods or passengers may be transported using multiple modes of transportation, such as on foot, bicycles, motorcycles, cars, buses, aircraft, watercraft and railroad trains, that are owned or leased by the traveler, or part of an ownership group the partner belongs to or are available for rent or hire. The multi-modal transportation system may include strings of multi-modal hubs connected, for example, by a rail-based mass transit system or a bus-based rapid transit system. The hubs may include features such as parking lots and rental lots, with the rental lot including storage for vehicles such as cars, motorcycles and bicycles. Around each hub may be roads, bicycle lanes and walkways so commuters may travel between hubs or to and from hubs and destinations using bicycles, rental cars or walking. In many cases, at least some of the modes of transportation operate on paths dedicated to that mode of transportation.

A ride-sharing system may include a trip-planning application installed to user's mobile devices. When the user's mobile device is within wireless transmission range of a vehicle, the trip-planning application may be configured to connect to and integrate with an in-vehicle computing platform of the vehicle. The trip-planning application may be configured to perform route optimization in accordance with information received from the connected vehicle, such as global positioning information. The trip-planning application may be configured to facilitate ride-sharing decision-making by taking into account the status of vehicle routes across the modes of transportation, and differences among costs, time, and other factors, such as the riders' characteristics, route policy (e.g., carpool lane, parking, speed limits, vehicle weight and size), and the number of vehicle occupants. Ride-sharing drivers using the trip-planning application may accordingly understand trade-offs among those factors, and make selections based on the recommendations (e.g., using the human-machine interface (HMI) of the vehicle, using the HMI of the user's mobile device, etc.). When out-of-range of a vehicle, the trip-planning application may be configured to operate autonomously, without integration with the vehicle HMI.

In some cases, a user may specify criteria other than location for the generation of a route. In an example, a user may specify time constraints indicative of what times are desired or required for the trip to take place, and/or cost constraints indicative of a maximum amount the user is willing to pay to make the trip. In yet other examples, the user may specify contextual constraints including elements of information to be tested, and a value against which the element is to be tested. For instance, a user may wish to arrive at a stadium when a game is scheduled to begin, without knowing exactly what time that would be. To evaluate the contextual constraints, the system may be configured to receive external constraint data sourced from a source of information external to the vehicle. As some possibilities, vehicle external elements of information may include weather conditions, movie playtimes, or game scores for professional sports.

In some cases, the information used to generate the route may change. For instance, if a sports game is delayed, then routes computed according to the time of the game to transport users to the stadium may also need to be delayed. By storing the generated routes, the system may be able to identify which routes are affected by the change in information, and may propose revised routes to the users.

This application is related to commonly-assigned application Ser. No. ______/Attorney Docket No. 83518974, filed concurrently herewith and titled “RIDE-SHARING USER PATH DISTURBANCES AND USER RE-ROUTING”; Ser. No. ______/Attorney Docket No. 83519006, filed concurrently herewith and titled “RIDE-SHARING RANGE CONTOURS”; Ser. No. ______/Attorney Docket No. 83519032, filed concurrently herewith and titled “RIDE-SHARING LONG-TERM RIDE-SHARE GROUPS”; and Ser. No. ______/Attorney Docket No. 83519041, filed concurrently herewith and titled “RIDE-SHARING JOINT-RENTAL GROUPS”, each of which is incorporated in its entirety herein by reference.

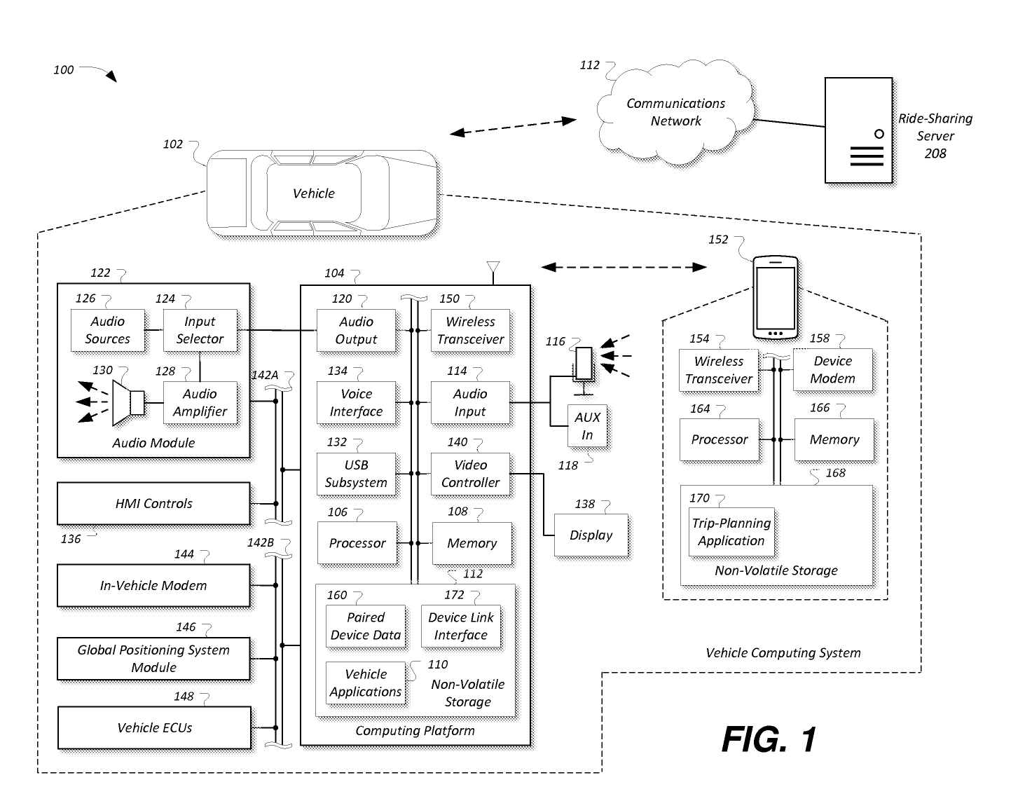

FIG. 1 illustrates an example system 100 including a vehicle 102 configured to access telematics servers and a mobile device 152 having a trip-planning application 170. The vehicle 102 may include various types of passenger vehicles, such as crossover utility vehicle (CUV), sport utility vehicle (SUV), truck, recreational vehicle (RV), boat, plane or other mobile machine for transporting people or goods. Telematics services may include, as some non-limiting possibilities, navigation, turn-by-turn directions, vehicle health reports, local business search, accident reporting, and hands-free calling. In an example, the vehicle 102 may include the SYNC system manufactured by The Ford Motor Company of Dearborn, Mich. It should be noted that the illustrated system 100 is merely an example, and more, fewer, and/or differently located elements may be used.

The computing platform 104 may include one or more processors 106 configured to perform instructions, commands and other routines in support of the processes described herein. For instance, the computing platform 104 may be configured to execute instructions of vehicle applications 110 to provide features such as navigation, accident reporting, satellite radio decoding, and hands-free calling. Such instructions and other data may be maintained in a non-volatile manner using a variety of types of computer-readable storage medium 112. The computer-readable medium 112 (also referred to as a processor-readable medium or storage) includes any non-transitory medium (e.g., a tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. For example, the computing platform 104 may include an audio input 114 configured to receive spoken commands from vehicle occupants through a connected microphone 116, and auxiliary audio input 118 configured to receive audio signals from connected devices. The auxiliary audio input 118 may be a physical connection, such as an electrical wire or a fiber optic cable, or a wireless input, such as a BLUETOOTH audio connection. In some examples, the audio input 114 may be configured to provide audio processing capabilities, such as pre-amplification of low-level signals, and conversion of analog inputs into digital data for processing by the processor 106.

The computing platform 104 may also provide one or more audio outputs 120 to an input of an audio module 122 having audio playback functionality. In other examples, the computing platform 104 may provide the audio output to an occupant through use of one or more dedicated speakers (not illustrated). The audio module 122 may include an input selector 124 configured to provide audio content from a selected audio source 126 to an audio amplifier 128 for playback through vehicle speakers 130 or headphones (not illustrated). The audio sources 126 may include, as some examples, decoded amplitude modulated (AM), frequency modulated (FM) or satellite digital audio radio service (SDARS) signals, and audio signals from compact disc (CD) or digital versatile disk (DVD) audio playback. The audio sources 126 may also include audio received from the computing platform 104, such as audio content generated by the computing platform 104, audio content decoded from flash memory drives connected to a universal serial bus (USB) subsystem 132 of the computing platform 104, and audio content passed through the computing platform 104 from the auxiliary audio input 118.

The computing platform 104 may utilize a voice interface 134 to provide a hands-free interface to the computing platform 104. An example spoken dialog system is described in U.S. Pat. No. 8,400,332, which is incorporated in its entirety by reference herein. The voice interface 134 may support speech recognition from audio received via the microphone 116 according to grammar associated with available commands, and voice prompt generation for output via the audio module 122. Different decoding speech strategies may be used, such as, phonetic, isolated word, word spotting, phrase recognition, large vocabulary continuous speech (LVCSR), etc. In some examples, different grammar languages and speech recognition engines may be utilized for the different strategies. The voice interface 134 may utilize probabilistic speech techniques using the grammar in comparison to the input speech. In many cases, the voice interface 134 may include a standard user profile tuning for use by the speech recognition functions to allow the speech recognition to be tuned to provide good results on average, resulting in positive experiences for the maximum number of initial users. In some cases, the system may be configured to temporarily mute or otherwise override the audio source specified by the input selector 124 when an audio prompt is ready for presentation by the computing platform 104 and another audio source 126 is selected for playback.

In some examples, a push-to-talk button may be configured to cause voice interface 134 to begin speech recognition. In another example, an “Open Mic” feature may be implemented where the user simply begins to speak without pressing a button. This may be implemented with a voice operated switch (VOX) or with an advanced LVCSR engine that activates for a predetermined set of phrases or words (e.g., a name of the system followed by please, followed by one of a specific set of verbs). The voice interface 134 may also support barge-in, whereby the speech synthesizer begins to provide a prompt before the user has finished the sentence (which is typical of natural speech where a listener begins to speak as soon as they understand the sentence, but before it is completed). Barge-in may also allow a dialog system to intentionally initiate a dialog during moments of silence, or to interrupt and ongoing conversation. This may be used as a tactic for conveying urgency, thus getting the user's attention.

The computing platform 104 may also receive input from human-machine interface (HMI) controls 136 configured to provide for occupant interaction with the vehicle 102. For instance, the computing platform 104 may interface with one or more buttons or other HMI controls configured to invoke functions on the computing platform 104 (e.g., steering wheel audio buttons, a push-to-talk button, instrument panel controls, etc.). The computing platform 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities.

The computing platform 104 may be further configured to communicate with other components of the vehicle 102 via one or more in-vehicle networks 142. The in-vehicle networks 142 may include one or more of a vehicle controller area network (CAN), an Ethernet network, and a media oriented system transfer (MOST), as some examples. The in-vehicle networks 142 may allow the computing platform 104 to communicate with other vehicle 102 systems, such as a vehicle modem 144 (which may not be present in some configurations), a global positioning system (GPS) module 146 configured to provide current vehicle 102 location and heading information, and various vehicle ECUs 148 configured to incorporate with the computing platform 104. As some non-limiting possibilities, the vehicle ECUs 148 may include a powertrain control module configured to provide control of engine operating components (e.g., idle control components, fuel delivery components, emissions control components, etc.) and monitoring of engine operating components (e.g., status of engine diagnostic codes); a body control module configured to manage various power control functions such as exterior lighting, interior lighting, keyless entry, remote start, and point of access status verification (e.g., closure status of the hood, doors and/or trunk of the vehicle 102); a radio transceiver module configured to communicate with key fobs or other local vehicle 102 devices; and a climate control management module configured to provide control and monitoring of heating and cooling system components (e.g., compressor clutch and blower fan control, temperature sensor information, etc.).

As shown, the audio module 122 and the HMI controls 136 may communicate with the computing platform 104 over a first in-vehicle network 142-A, and the vehicle modem 144, GPS module 146, and vehicle ECUs 148 may communicate with the computing platform 104 over a second in-vehicle network 142-B. In other examples, the computing platform 104 may be connected to more or fewer in-vehicle networks 142. Additionally or alternately, one or more HMI controls 136 or other components may be connected to the computing platform 104 via different in-vehicle networks 142 than shown, or directly without connection to an in-vehicle network 142.

The computing platform 104 may also be configured to communicate with mobile devices 152 of the vehicle occupants. The mobile devices 152 may be any of various types of portable computing device, such as cellular phones, tablet computers, smart watches, laptop computers, portable music players, wearable devices, E-textiles or other devices capable of communication with the computing platform 104. In many examples, the computing platform 104 may include a wireless transceiver 150 (e.g., a BLUETOOTH module, a ZIGBEE transceiver, a Wi-Fi transceiver, an IrDA transceiver, an RFID transceiver, etc.) configured to communicate with a compatible wireless transceiver 154 of the mobile device 152. Additionally or alternately, the computing platform 104 may communicate with the mobile device 152 over a wired connection, such as via a USB connection between the mobile device 152 and the USB subsystem 132. In some examples the mobile device 152 may be battery powered, while in other cases the mobile device 152 may receive at least a portion of its power from the vehicle 102 via the wired connection.

The communications network 156 may provide communications services, such as packet-switched network services (e.g., Internet access, VoIP communication services), to devices connected to the communications network 156. An example of a communications network 156 may include a cellular telephone network. Mobile devices 152 may provide network connectivity to the communications network 156 via a device modem 158 of the mobile device 152. To facilitate the communications over the communications network 156, mobile devices 152 may be associated with unique device identifiers (e.g., mobile device numbers (MDNs), Internet protocol (IP) addresses, etc.) to identify the communications of the mobile devices 152 over the communications network 156. In some cases, occupants of the vehicle 102 or devices having permission to connect to the computing platform 104 may be identified by the computing platform 104 according to paired device data 160 maintained in the storage medium 112. The paired device data 160 may indicate, for example, the unique device identifiers of mobile devices 152 previously paired with the computing platform 104 of the vehicle 102, such that the computing platform 104 may automatically reconnected to the mobile devices 152 referenced in the paired device data 160 without user intervention. In some vehicles 102, the computing platform 104 wireless transceiver 154 may be configured to provide hotspot functionality to user's mobile devices 152.

When a mobile device 152 that supports network connectivity is paired with the computing platform 104, the mobile device 152 may allow the computing platform 104 to use the network connectivity of the device modem 158 to communicate over the communications network 156 with the remote telematics server 162 or other remote computing device. In one example, the computing platform 104 may utilize a data-over-voice plan or data plan of the mobile device 152 to communicate information between the computing platform 104 and the communications network 156. Additionally or alternately, the computing platform 104 may utilize the vehicle modem 144 to communicate information between the computing platform 104 and the communications network 156, without use of the communications facilities of the mobile device 152.

Similar to the computing platform 104, the mobile device 152 may include one or more processors 164 configured to execute instructions of mobile applications loaded to a memory 166 of the mobile device 152 from storage medium 168 of the mobile device 152. In some examples, the mobile applications may be configured to communicate with the computing platform 104 via the wireless transceiver 154 and with the remote telematics server 162 or other network services via the device modem 158. The computing platform 104 may also include a device link interface 172 to facilitate the integration of functionality of the mobile applications into the grammar of commands available via the voice interface 134. The device link interface 172 may also provide the mobile applications with access to vehicle information available to the computing platform 104 via the in-vehicle networks 142. An example of a device link interface 172 may be the SYNC APPLINK component of the SYNC system provided by The Ford Motor Company of Dearborn, Mich.

A trip-planning application 170 may be an example of an application installed to the mobile device 152 and configured to utilize the device link interface 172 to interact with the computing platform 104. When connected to the vehicle 102, the trip-planning application 170 may be configured to utilize information from vehicle sensors, actuators and electronic control units made available via the vehicle bus 142. The trip-planning application 170 may also be configured to operate when untethered from the vehicle 102, such as when the user is riding public transportation or walking. The trip-planning application 170 may be further configured to communicate with servers via the communications network 156, as discussed in detail below. The user may interact with the trip-planning application 170 through the HMI of the mobile device 152, via a web interface, or via the HMI of the vehicle 102, to avoid distraction while driving.

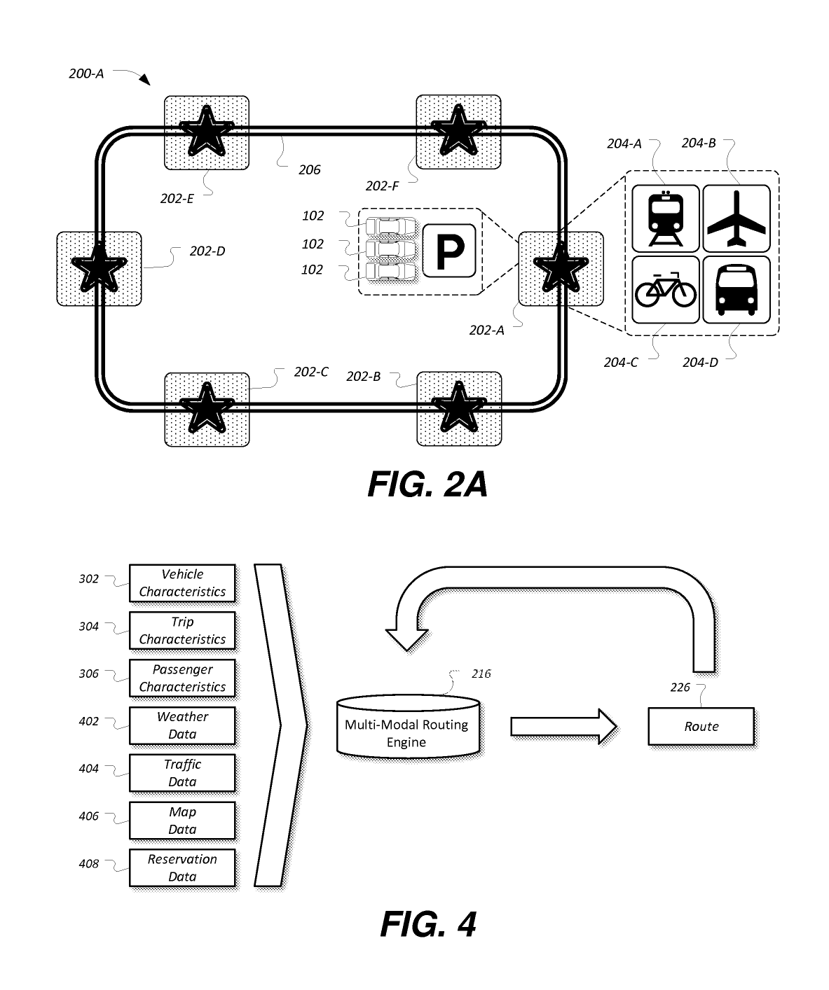

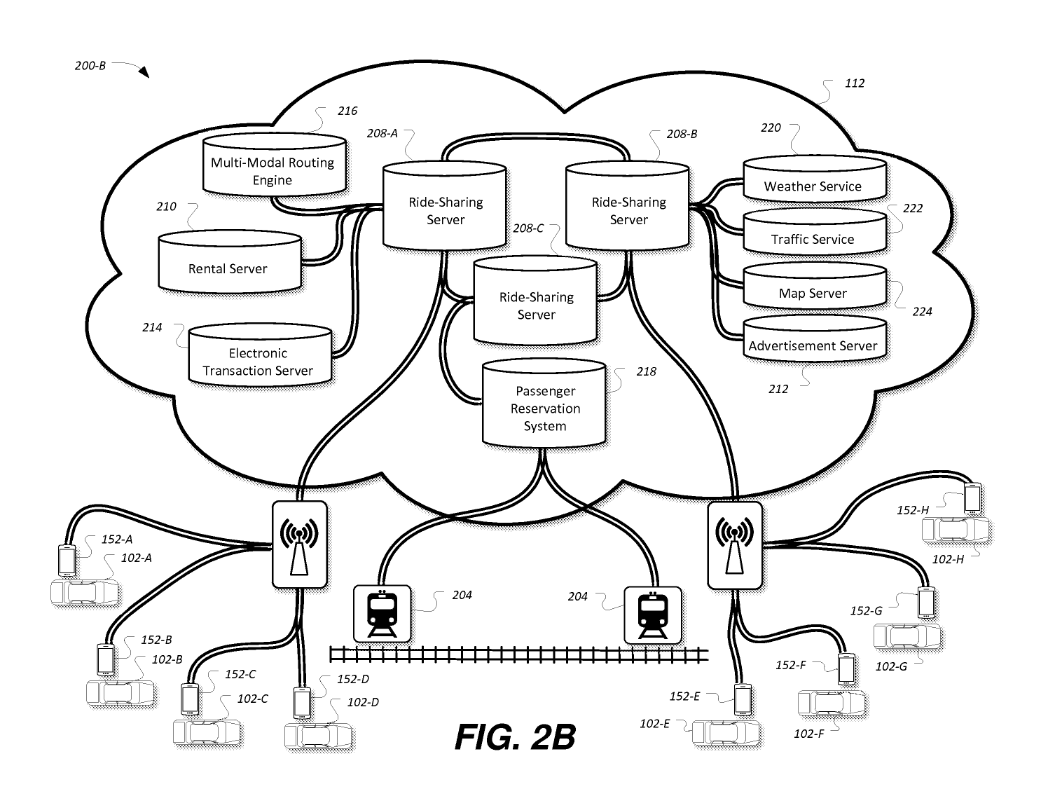

FIG. 2A illustrates an example logical diagram of a multi-modal transportation system 200. As shown, the multi-modal transportation system 200 may include multi-modal hubs 202-A through 202-F (collectively 202). The multi-modal hubs 202 may be connected by mass transportation systems 204, such as one or more of a rail-based mass transportation system (e.g., trains 204-A), an air-based mass transportation system (e.g., airplanes 204-B), a road-based transportation system (e.g., bicycles 204-C, buses 204-D, etc.), and a water-based transportation system (not pictured). The system 200 may include vehicles 102 such as cars, trucks, bicycles, train cars, or other transportation vehicles or devices, which may traverse paths 206 to facilitate the movement of users from location to location.

The hubs 202 may be configured to make the transportation systems 204 available to users of the system 200. The transportation systems 204 may include, as some possibilities, ride-sharing services, vehicle rental services, and bike rental services. These services may include a car sharing service such as the Zipcar subsidiary of Avis Budget Group of Cambridge, Mass., a bicycle sharing service such as the Hubway bicycle sharing system of Boston, Mass., a taxi service, or another service in which the vehicles 102 may be rented or hired temporarily (e.g., using the mobile device 152) or utilized for a specific purpose or trip (e.g., a one-way trip). It should also be noted that in some cases the users may utilize their own vehicles 102. The hubs 202 may be configured to store vehicles 102 of the transportations systems 204, such as rented or hired vehicles 102 awaiting a rider. The hubs 202 may be configured to store vehicles 102 of individuals, typically by lease or ownership. In an example, the hubs 202 may include a parking lot or other storage for individual-owned transit vehicles 102 (e.g., cars, trucks, bicycles, etc.) and a rental lot or other storage for storage of rental transit vehicles 102 (e.g., cars, motorcycles, bicycles, etc.). The hubs 202 additionally or alternately may include one or more of storage for aircraft, trains, buses, etc. that are often not individually owned or leased, but are owned or leased by a firm or public authority.

The hubs 202 may also include lodging, restaurants, health clubs, temporary office space, meeting rooms and other services for extended stays, and storage for luggage and parcel shipping and receiving. The hubs 202 may also include has internal transportation systems. Walking within hubs 202 may be an option for intra-hub travel, but such travel may be expedited by escalators, elevators and moving walkways. The hubs 202 may also include buses, trains, trams, shuttles, Segways, carts, and other vehicles 102 for transportation within the hub 202 itself.

The hubs 202 may further be located within proximity to one or more routable paths 206 (such as roads, bicycle lanes and walkways), such that users may traverse the paths 206 to travel between hubs 202 or between hubs 202 and other destinations using the vehicles 102 or walking. In some cases, the paths 206 may be shared across modes of transportation (e.g., personal vehicles 102 and taxi vehicles 102), while in other cases, the paths 206 may differ according to transportation mode (e.g., trains and buses traverse different paths 206). An ordered set of paths 206 that may be traversed by a user to get from one location to another may be referred to herein as a route 226 (discussed in more detail below). It should be noted that terminology may varies between surface, nautical and aeronautical navigation. For instance, automobile routing systems may refer to an origin, a set of maneuvers, and a destination. There may further be waypoints connected by legs between each maneuver. A maneuver may be an intersection and waypoints between maneuvers describe the shape of the roads. Selection of a route may be done sequentially, e.g., by eliminating the least acceptable routes and introducing additional selective criteria and removing more unacceptable routes until one route is selected. However, unexpected or unlikely events may occur and a previously unacceptable route becomes preferred. With dynamic routing the route selection may change while underway.

FIG. 2B illustrates an example network diagram 200-B of the multi-modal transportation system 200. As shown, the communications network 156 may support communication between various components, such as mobile devices 152 of the users (whether in riding in vehicles 102 or not), ride-sharing servers 208-A, 208-B, 208-C (collectively 208), a rental server 210, an advertisement server 212, a transaction server 214, a multi-modal routing engine 216, a passenger reservation system 218, a weather service 220, a traffic service 222, and a map server 224. The system 200 may take many different forms and includes multiple and/or alternate components and facilities. While an exemplary system 200 is shown in FIG. 2B, the exemplary components illustrated of the system 200 are not intended to be limiting. Indeed, additional or alternative components and/or implementations may be used. As one example, some or all of the functionality of the multi-modal routing engine 216 may be integrated into the ride-sharing server 208.

The ride-sharing servers 208 may be configured to manage the vehicles 102 of the system 200. As shown, the multi-modal transportation system 200 includes a plurality of vehicles 102-A through 102-H (collectively 102) configured to communicate with the ride-sharing servers 208 (e.g., with or without use of the mobile device 152). The ride-sharing servers 208 may be configured to serve as points of contact for the users of the trip-planning application 170 to interact with the services of the multi-modal transportation system 200. These services may include, as some possibilities, dynamic intermediate transportation mode options, planning of trips for ride-sharing passengers and drivers (e.g., instant ridesharing, dynamic ridesharing, ad-hoc ridesharing, dynamic carpooling, etc.), and vehicle 102 position tracking. The ride-sharing servers 208 may accordingly provide ride-sharing services to users of the system 200, allowing them to efficiently car-pool either within a hub 202 or upon arrival at a hub 202. This may accordingly speed movement through the transportation hub 202 by automatically finding ride-share partners while traveling on the mass transportation system 204 rather than trying to do an ad-hoc ride-share in the transportation hub 202, e.g., hailing a taxi upon arrival at an airport.

The ride-sharing servers 208 may further provide services to parties other than the users of the trip-planning application 170. For instance, the ride-sharing servers 208 may provide notification to the transportation systems 204 when a particular mode of transportation is selected by a user, which allows for allocation of vehicles 102 to routes 226 for the users of the system 200. In another example, short-term rental vehicles 102 may be managed by a rental server 210. The short-term rental vehicles 102 may be booked by the users via the rental server 210 and the details of the rental (e.g., cost, days rented, etc.) may be provided to the ride-sharing servers 208 for use in facilitating ride-sharing using the rented vehicle 102. For instance, the ride-sharing servers 208 may identify rented vehicles 102 or ride-sharing vehicles 102 to users that have arrived in a hub 202 by a mass transit transportation system 204 and are in need of a vehicle 102 to ride-share in to travel between the transportation hub 202 and a final destination. The identification may include, for examples, indicating when and where the rented vehicles will be at the hub 202. For instance, if the users of the trip-planning application 170 users are foreigners, the user interface may be provided in different languages.

The advertisement server 212 may be configured to aggregate information from transportation systems 204 to attract users and to offer special discounts in return for inconvenience such as changing a trip time, etc. The advertisement server 212 may be further configured to provide a revenue stream to operate the system 200, although the system 200 may additionally or alternatively use a subscription model to meet operational and fixed costs.

The transaction server 214 may be configured to operate as a wallet server to provide travelers with a way to purchase tickets, rent vehicles 102, etc., from the user's mobile device 152. In an example, the transaction server 214 may be configured to manage account information for users of the system, to facilitate users making and receiving payment for sharing a vehicle 102, as well as to accumulate transactions over a billing cycle (e.g., 30 days, etc.), and provide a credit, disbursement, or bill to the user at the end of the billing cycle. Accordingly, the transaction server 214 may allow for financial aspects of the ride-sharing to be performed without cash or credit transactions being performed in the vehicles 102 or hubs 202, speeding movement through the transportation centers by avoiding stops at ticket counters, as an example.

As some other possibilities, the transaction server 214 may facilitate shared ownership of transportation assets such as vehicles 102 or seats on vehicles 102, for example, a group of users may collectively own a fleet of vehicles according to a joint ownership agreement. The transaction server 214 may accordingly provide access to the shared transportation assets as determined by the joint ownership rules. Further, the transportation assets may be available to be leased, owned and shared to other users, e.g., to provide exclusive use of a seat to an individual or group in exchange for a down payment and a recurring fee. If a non-owner uses a seat that is available but owned by other users, the non-owner may pay the group who owns it for use of the seat. As another example, an employer may buy a seat for its employees. The seat may be assigned or at large, may be assigned to a specific class. If the class is full the user may be entitled to a coupon or some remuneration. The transaction server 214 may enable these ownership models, as well as facilitating accounting of payments between the users.

The multi-modal routing engine 216 may be configured to provide routing services to the ride-sharing servers 208. As discussed in detail below, the multi-modal routing engine 216 may be configured to identify travel times and paths 206 for a specific trip, as well as to identify and update routes 226 that may be affected by traffic disturbances or other travel issues, such as a vehicle 102 accident or a water main break. In some cases, the multi-modal routing engine 216 may be integrated into one or more of the ride-sharing servers 208, while in other cases some or all of the functionality of the multi-modal routing engine 216 may be separate from and callable by the ride-sharing servers 208.

The ride-sharing servers 208 may be further configured to communicate with other networked sources of information as well. In an example, the ride-sharing servers 208 may be configured to receive information from a passenger reservation system 218 of a transportation system 204, such as ticket information and train or other scheduling information. In another example, the ride-sharing servers 208 may be configured to receive information from a weather service 220 configured to provide information indicative of historical, current and/or forecast environmental conditions. In a further example, the ride-sharing servers 208 may be configured to receive information from a traffic service 222 configured to provide information indicative of historical, current and/or forecast traffic conditions along the paths 206. In yet a further example, the ride-sharing servers 208 may be configured to receive map information, such as path 206 information and route 226 information from the map server 224.

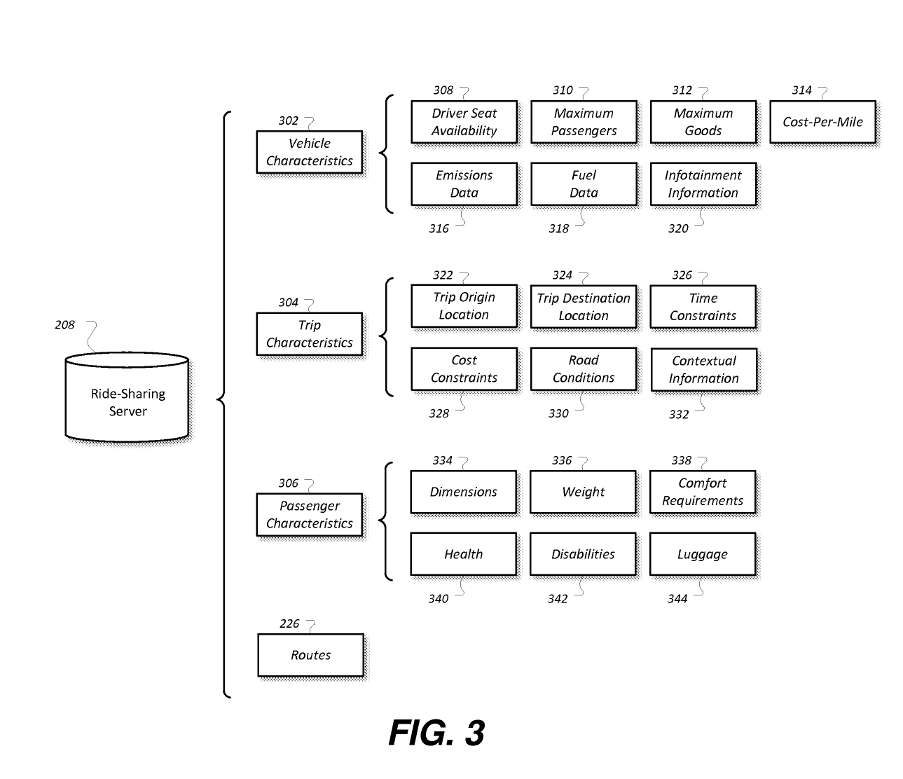

FIG. 3 illustrates an example data diagram 300 of characteristics useful for the generation of a route 226. These characteristics may include, as some non-limiting categories, vehicle characteristics 302, trip characteristics 304, and passenger characteristics 306.

The vehicle characteristics 302 may include one or more characteristics of a vehicle 102. The vehicle characteristics 302 may include information indicative of a current status of the vehicle 102, as well as information indicative of the capabilities of the vehicle 102 itself, independent of any current status. As some examples, the vehicle characteristics 302 may include a driver seat availability 308 indicative of whether or not a user is allocated to the vehicle 102 (and if so, optionally an identifier of the user), a maximum number of passengers 310 that may be simultaneously transported using the vehicle 102 (e.g., a seat belt count, etc.), a maximum amount of goods 312 that may be transported by the vehicle 102 (e.g., maximum weight, length, measure of volume, etc.), a cost-per-mile for operation 314 of the vehicle 102 (e.g., fuel efficiency information, rental cost per mile information, etc.), emissions data 316 (e.g., cleanliness of operation of the vehicle 102), fuel data 318 (e.g., a measure of liquid fuel quantity and type or battery state of charge currently available), and infotainment information 320 (e.g., whether video, calling, connectivity, or other features are available).

The trip characteristics 304 may include one or more characteristics of a user trip to be performed over the multi-modal transportation system 200. As some examples, the trip characteristics 304 may include information such as trip origin location 322 and trip destination location 324 (e.g., specified as GPS coordinates, addresses, etc.), time constraints 326 indicative of what times are desired or required for the trip to take place (e.g., a time of arrival to the destination, a time of departure based on a previous event such as arrival at a hub 202 due to a previous trip, etc.), cost constraints 328 (e.g., a maximum amount the user is willing to pay to make the trip), road conditions 330 (e.g., traffic, road closures, weather, visibility, etc.), and contextual information 332 (e.g., timing requirements such as to arrive at a movie showing, a phrase such as “I wish to travel when the tulips bloom and the temperature is above 35°,” “take a route next to a park,” etc.).

The passenger characteristics 306 may include one or more characteristics of a passenger desiring to make a trip. The passenger characteristics 306 may include trip-specific information for the passenger, and/or characteristics of the passenger that are independent of the particular trip. As some examples, the passenger characteristics 306 include passenger dimensions 334 (e.g., height, width, etc.), passenger weight 336 (e.g., kilograms), passenger comfort requirements 338 (e.g., heating/cooling settings, massaging seat settings, etc.), health information (e.g., whether the passenger is sick, prone to motion sickness, has special allergies such as pollen or tobacco, etc., requiring different routes or accommodations), disabilities information 342 (e.g., whether the passenger has impairments in movement or other characteristics that may affect travel), and luggage 344 (e.g., information regarding count, weight, and/or dimensions of luggage). The passenger characteristics 306 may include other information as well, such as a language preference to be used by the HMI of the trip-planning application 170.

FIG. 4 illustrates an example data flow diagram 400 for constructing a route 226. As shown, the multi-mode routing engine 216 may receive the vehicle characteristics 302, the trip characteristics 304, the passenger characteristics 306, weather data 402 from the weather service 220, traffic data 404 from the traffic service 222, map data 406 from the map server 224, and reservation data 408 from the passenger reservation system 218. Using the received information, the multi-mode routing engine 216 may compute a route 226 including an ordered set of one or more paths 206 that may be traversed by a user.

The multi-mode routing engine 216 may be configured to identify time and cost values for various paths 206 through the multi-modal transportation system 200. In an example, the multi-mode routing engine 216 may receive map data 406 (e.g., that includes mass transit schedules, forecast arrival and departure times and actual departure and arrival times. For example, ferry schedule information may include path 206 lengths (e.g., meters) and/or path traversal cost information (e.g., estimated traffic-free travel times). The multi-mode routing engine 216 may be further configured to adjust these values in accordance with current conditions. For instance, the multi-mode routing engine 216 may utilize the weather data 402 to decrease estimated rates of travel (e.g., estimated km/hour over the paths 206 to account for account for rain, snow, ice, fog or other weather conditions. As another possibility, the multi-mode routing engine 216 may utilize the traffic data 404 to decrease estimated rates of travel over specific paths 206 identified as being slow or blocked (e.g., based on actual vehicle 102 travel time data measured from roadway loop sensors, cameras, etc.). As yet a further possibility, when a mass transportation mode is running under capacity, the multi-mode routing engine 216 may decrease costs for users traversing that system over another mode of transportation, while if the mass transportation mode is at capacity or above, the multi-mode routing engine 216 may increase costs for users traversing that system.

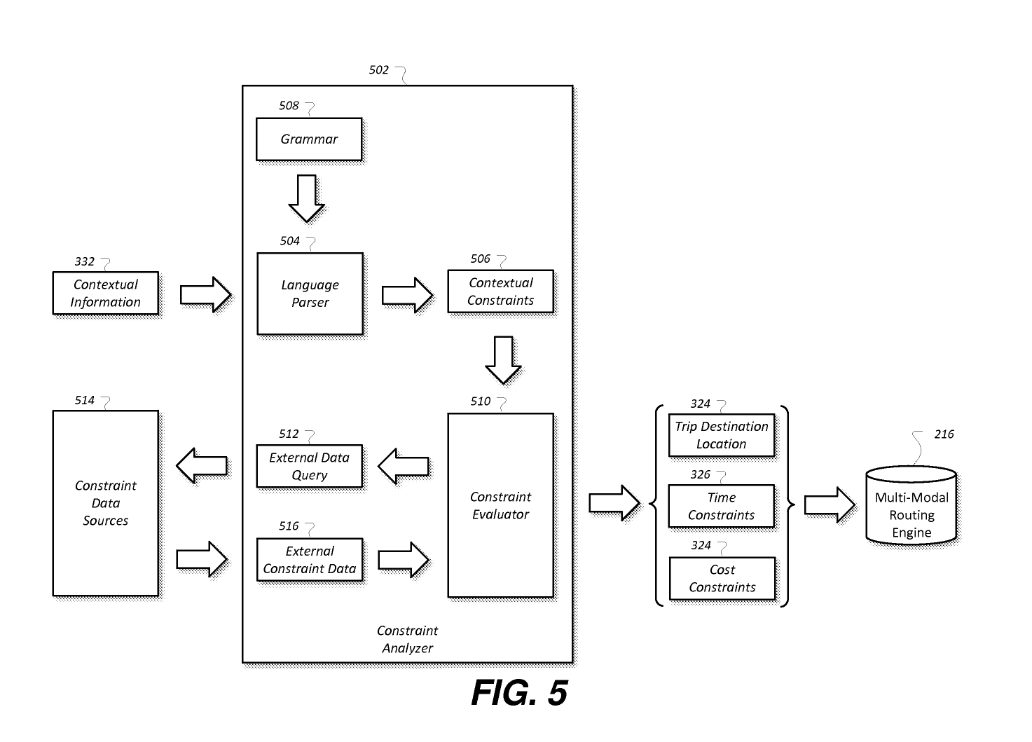

The multi-mode routing engine 216 may be further configured to utilize the determined path 206 values to construct one or more routes 226 from a trip origin location 322 to a trip destination location 324 that conform to the time constraints 326 and the cost constraints 328 of the trip characteristics 304. For example, the multi-mode routing engine 216 may utilize a least-cost routing algorithm to determine candidate routes 226 from the trip origin location 322 to a trip destination location 324, and then may discard those routes that do not confirm to the time constraints 326 and the cost constraints 328. In an example, the multi-mode routing engine 216 may prefer time constraints 326 over cost constraints 328 in cases where no route 226 meets both the time constraints 326 and the cost constraints 328. In another example, the multi-mode routing engine 216 may utilize information within the trip characteristics 304 or passenger characteristics 306 of the user requesting the route to determine whether to prefer time constraints 326 over cost constraints 328 or vice versa. Further aspects of constraint analysis are discussed in detail below with respect to FIG. 5.

The identified routes 226 may accordingly be provided to the user. Moreover, the identified routes 226 may be maintained by the ride-sharing server 208 as well. When vehicles 102 are typically rented or trips are booked, users may typically not provide insight to the system 200 into the travel plans for the users across multiple modes of transportation. However, by storing the identified routes 226, the ride-sharing server 208 may be configured to perform operations in relation to the multiple modes of transportation that might be otherwise unavailable.

FIG. 5 illustrates an example data flow diagram 500 for a constraint analyzer 502 analyzing which routes 226 satisfy specified constraints. As shown, the constraint analyzer 502 may include a natural language parser 504 configured to determine contextual constraints 506 based on the contextual information 332, and a constraint evaluator 510 configured to use in-vehicle information and/or vehicle-external constraint data 516 from various constraint data sources 514 to evaluate the contextual constraints 506. By using the constraint analyzer 502, the multi-mode routing engine 216 may be configured to provide for routing of vehicles 102 based on complex constraints, instead of or in addition to time constraints 326 or cost constraints 328.

In some cases, the contextual information 332 may be input by the user via a one or more dropdown controls including categories and/or items of information to be evaluated (e.g., tomorrow's high or low temperature, a local sport's team's score for a particular game, etc.) and values with which to compare to the category and/or item (e.g., 35 degrees, a score of 14-0, etc.) In other cases, the contextual information 332 may be input by the user via a keyboard or other textual interface.

In still other cases, the contextual information 332 may be provided verbally by the user (e.g., by verbal discourse with the user). In such an example, identifying the contextual constraints 506 may use speech recognition techniques to translate spoken words into text or another computer-readable form, and analysis of the transcribed words. For instance, a user may initiate speech recognition, such as by pressing a push-to-talk button of the vehicle HMI controls 163, selecting a user interface control of the HMI of the mobile device 152, or speaking a key phrase to begin speech recognition. Following the initiation of speech recognition, the system may accept the speech input. In an example, when the mobile device 152 is paired with the vehicle 102, the voice recognition may be performed using features of the vehicle 102 itself, such as via the voice interface 134. In another example, the mobile device 152 may be configured to perform the voice recognition, or may be configured to send recorded audio of the speech input to a remote service for transcription, and may receive the output from the remote service. In yet a further example, the mobile device 152 may provide recorded audio of the speech input to the ride-sharing server 208 for recognition.

In some examples, speech recognition may be employed where speech is processed by several processors in series. Early in the pipeline speech features may be extracted with a signal processing engine that reduces noise and normalizes volume of the speech data, while later in the pipeline large-vocabulary continuous speech recognition (LVCSR) may be performed. Moreover, in some examples, voice recognition may be used to identify the speaker before discourse begins, to ensure that traveler (user) is the same person throughout the discourse, and to handle discourse from multiple voices.

Regardless of how the contextual information 332 is input, the language parser 504 may be configured to identify one or more conditions specified within the contextual information 332 of the trip characteristics 304. These conditions may be referred to as the contextual constraints 506, and may include an element of information to be tested, and a value against which the element is to be tested. For instance, in cases where the contextual information 332 is being input by the user via a one or more dropdown controls, the contextual information 332 may simply include the contextual constraints 506. In other cases, such as when textual or voice input is received, the language parser 504 may be configured to utilize a grammar to identify the elements of information and values against which to be tested.

As one possibility, the language parser 504 may utilize a grammar 508 defining words and patterns of words to be identified in the contextual information 332. The grammar 508 may include a set of possible phrases that may be used to allow users to specify conditions. In an example, the grammar 508 may be configured to recognize a phrase such as “take a route next to a [map category],” where the map category element may be one of a set of predefined items, such as lake, park, bridge, or may be a specific address or point of interest, such as times square. In another example, the grammar 508 may be configured to recognize a phrase such as “when the temperature is above [number],” where the number is a temperature. The grammar 508 may be implemented in various speech recognition formats, such as, in an example, in accordance with the Speech Recognition Grammar Specification Version (SRGS) maintained by the World Wide Web Consortium (W3C).

The constraint evaluator 510 may be configured to evaluate the contextual constraints 506 into other criteria that may be used by the multi-modal routing engine 216. In an example, when the contextual constraint 506 specifies a time when an event occurs, the constraint evaluator 510 may be configured to evaluate the contextual constraint 506 into a time constraint 326 for use by the multi-modal routing engine 216. In another example, when the contextual constraint specifies a location, the constraint evaluator 510 may be configured to evaluate the contextual constraint 506 into an intermediate waypoint or trip destination location 324 for use by the multi-modal routing engine 216 between the trip origin location 322 and trip destination location 324 of the trip characteristics 304. In yet a further example, when the contextual constraint specifies a cost, the constraint evaluator 510 may be configured to evaluate the contextual constraint 506 into a cost constraint 328 for use by the multi-modal routing engine 216.

In some cases, the contextual constraints 506 may include conditions based on elements of information of the vehicle 102. As some possibilities, the contextual constraints 506 may specify elements of constraint data 516 readily available without an external source, such as a time of day, day of the week. Or, the contextual constraints 506 may specify elements of constraint data 516 specifying information available via the vehicle 102, such as level of fuel remaining. The constraint evaluator 510 may accordingly be configured to evaluate such contextual constraints 506 by querying the vehicle 102 for information (e.g., via a network request to the computing platform 104 of the vehicle 102).

In other examples, the contextual constraints 506 may include conditions that require external constraint data 516 sourced from a source of information external to the vehicle 102. As some possibilities, vehicle external elements of information may include weather conditions, movie playtimes, or game scores for professional sports. In such examples, the constraint evaluator 510 may be configured to formulate an external data query 512 to provide to a constraint data source 514, where the constraint data source 514 may in turn return the external constraint data 516 to the constraint evaluator 510 for processing. As a more specific example, if a contextual constraint 506 specifies a time when an event occurs that may produce a significant traffic anomaly or that the user is intending to arrive at (e.g., when an outside temperature is expected to reach 50 degrees, a time of a sports game or other venue event), the external data query 512 may request for the constraint data source 514 to return that event time to the constraint evaluator 510 as external constraint data 516.

Once evaluated, the constraint evaluator 510 may be configured to provide the evaluated contextual constraints 506 as the other criteria (e.g., time constraints 326, intermediate waypoint or trip destination locations 324, cost constraints 328, etc.) for use by the multi-modal routing engine 216 as discussed above with respect to the data flow diagram 400. The multi-modal routing engine 216 may accordingly use the evaluated contextual constraints 506 to generate the route 226. The route 226 may be provided to the user, and may also be maintained by the ride-sharing server 208.

In some cases, the multi-mode routing engine 216 may receive updated information that may affect the generated route 226. In an example, the ride-sharing server 208 may be configured to periodically poll for external constraint data 516 for contextual constraints 506 specified by routes 226 maintained by the ride-sharing server 208. These may include, for instance, routes 226 that are in-progress, or that have not been started. In another example, the ride-sharing server 208 may be configured to subscribe to the constraint data sources 514 to receive updated external constraint data 516 used by the contextual constraints 506 of the routes 226. When changed data for a subscribed external constraint data 516 element is received, the ride-sharing server 208 may further be configured to identify which routes 226 may be disturbed by the change, and may recalculate those routes 226. For instance, if a sports game time for the day is delayed, then routes 226 specified to transport users to the stadium for the game may need to be delayed. The ride-sharing server 208 may be further configured to send messages to the affected ride-sharing users indicating the updated routes 226.

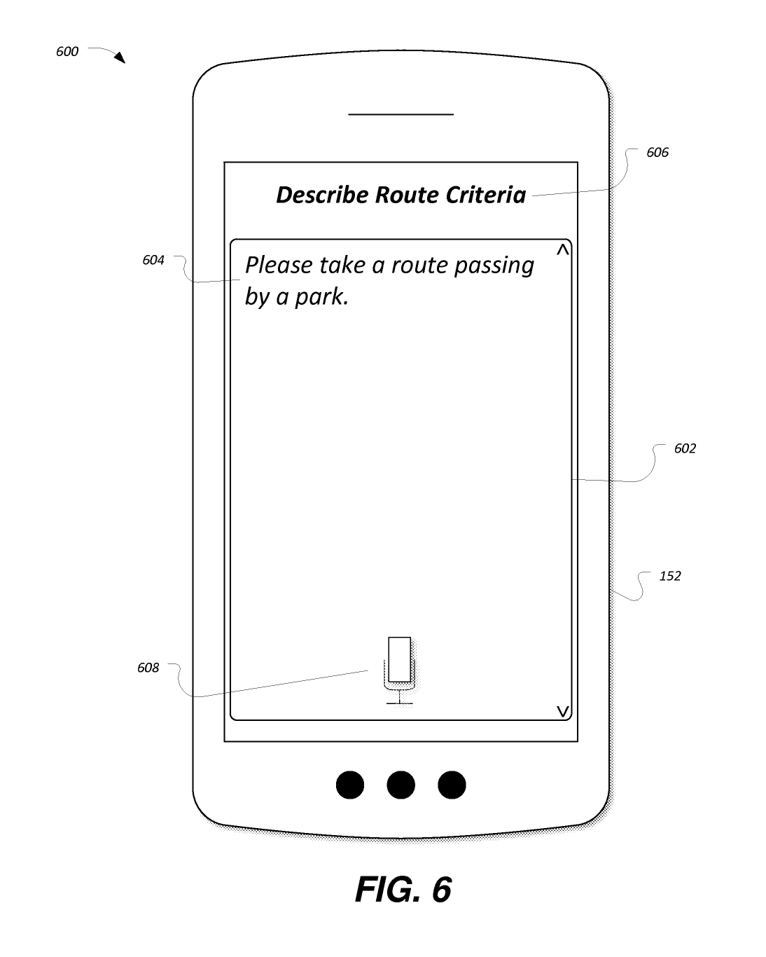

FIG. 6 illustrates an example user interface 600 of the trip-planning application 170 for specifying contextual constraints 506 for a route 226. As illustrated, the user interface 600 may be presented to the user trip-planning application 170 via a display of the mobile device 152. As another possibility, the user interface 600 may be provided to the user via a display of a paired vehicle 102.

The user interface 600 may include a text control 602 configured to display a textual representation 604 of spoken or typed input from the user specifying the contextual constraints 506. For instance, the user interface 600 may further include a voice input icon 606 that, when selected, causes the trip-planning application 170 to enter recognition mode for spoken text. Or, the user interface 600 may support use of a keyboard (not shown) for the entering of the textual representation 604 of the contextual constraints 506. In yet further examples (also not shown), the user interface 600 may include one or more dropdown controls including categories and/or items of information to be evaluated (e.g., tomorrow's high or low temperature, a local sport's team's score for a particular game, etc.) and values with which to compare to the category and/or item (e.g., 35 degrees, 14-0, etc.). The user interface 600 may also include a title label 608 to indicate to the user that the user interface 600 is for input of contextual constraints 506 for a route 226.

Responsive to entering the contextual constraints 506, or upon receiving specific direction from the user, the trip-planning application 170 may be configured to send the contextual constraints 506 to the ride-sharing server 208 for processing. In another example, the trip-planning application 170 may be configured to send the contextual constraints 506 to the computing platform 104 of the vehicle 102 for processing, or may process the contextual constraints 506 by the mobile device 152. Regardless of approach, the contextual constraints 506 may accordingly be utilized to facilitate the determination of the route 226 for the user.

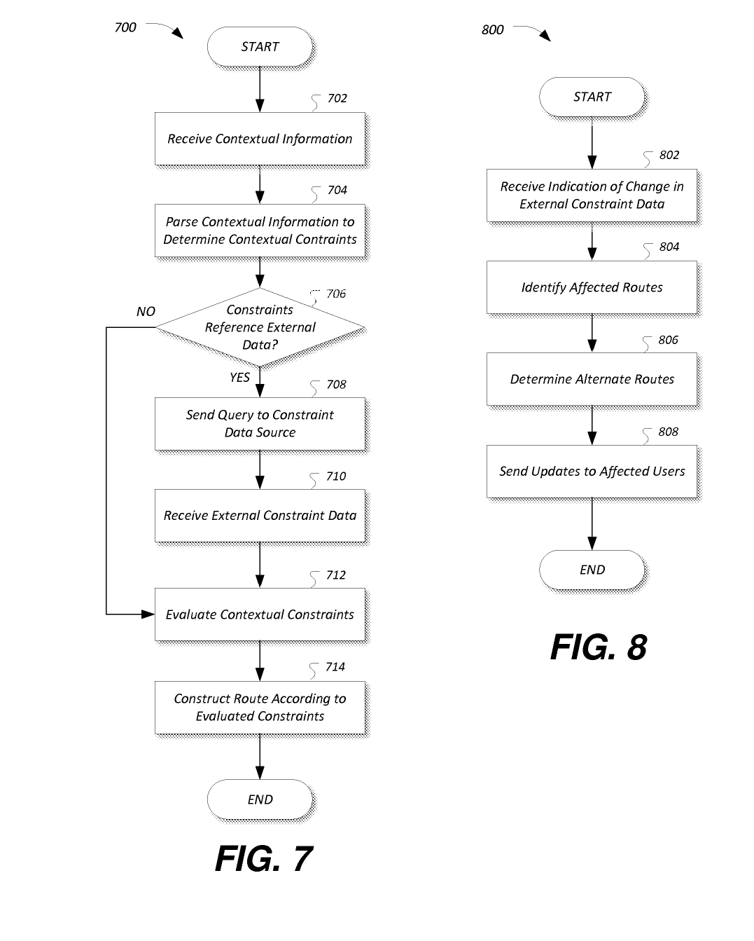

FIG. 7 illustrates an example process 700 for constructing a route 226. The process 700 may be performed, in an example, by the ride-sharing server 208 and the multi-mode routing engine 216.

At operation 702, the ride-sharing server 208 receives contextual information 332. In an example, the user may specify the contextual information 332 using the user interface 600 of the trip-planning application 170.

At operation 704, the ride-sharing server 208 parses the contextual information 332 to determine contextual constraints 506. In an example, the ride-sharing server 208 may utilize a language parser 504 and grammar 508 of a constraint analyzer 502 to parse the contextual information 332 into contextual constraints 506.

At operation 706, the ride-sharing server 208 determines whether the contextual constraints 506 reference external constraint data 516. In an example, the ride-sharing server 208 may utilize a constraint evaluator 510 of a constraint analyzer 502 to identify whether any of the contextual constraints 506 specify comparison with an external source of information such as a remote server storing sports game schedules or the vehicle 102 itself.

At operation 708, the ride-sharing server 208 sends an external data query 512 to a constraint data source 514. In an example, the ride-sharing server 208 may utilize the constraint evaluator 510 to formulate the external data query 512 to provide to the constraint data source 514 and send the external data query 512 to the constraint data source 514. In some cases, the ride-sharing server 208 may also subscribe to the constraint data source 514 to receive updates or other changes to the external constraint data 516.

At operation 710, the ride-sharing server 208 receives the external constraint data 516 from the constraint data source 514. In an example, the ride-sharing server 208 may utilize the constraint evaluator 510 to receive the external constraint data 516 responsive to the external data query 512.

At operation 712, the ride-sharing server 208 evaluates the contextual constraints 506 in the context of the external constraint data 516. In an example, when the contextual constraint 506 specifies a time when an event occurs, the constraint evaluator 510 may be configured to evaluate the contextual constraint 506 into a time constraint 326 for use by the multi-modal routing engine 216. In another example, when the contextual constraint specifies a location, the constraint evaluator 510 may be configured to evaluate the contextual constraint 506 into an intermediate waypoint or trip destination location 324 for use by the multi-modal routing engine 216 between the trip origin location 322 and trip destination location 324 of the trip characteristics 304. In yet a further example, when the contextual constraint specifies a cost, the constraint evaluator 510 may be configured to evaluate the contextual constraint 506 into a cost constraint 328 for use by the multi-modal routing engine 216.

At operation 714, the ride-sharing server 208 constructs a route 226 according to the evaluated contextual constraints 506. In an example, the ride-sharing server 208 may utilize the multi-mode routing engine 216, the evaluated contextual constraints 506 and other route 226 information to compute a route 226 including an ordered set of one or more paths 206 that may be traversed by a user. An example data flow diagram 400 for constructing a route 226 is discussed above with respect to FIG. 4. After operation 714, the process 700 ends.

FIG. 8 illustrates an example process 800 for automatically updating a route 226 based on an indication of a change in external constraint data 516. As with the process 700, the process 800 may be performed by the ride-sharing server 208.

At operation 802, the ride-sharing server 208 receives an indication of a change in external constraint data 516. In an example, the ride-sharing server 208 may periodically poll for external constraint data 516 for contextual constraints 506 specified by routes 226 maintained by the ride-sharing server 208. These may include routes 226 that are in-progress, or that have not been started. In another example, the ride-sharing server 208 may subscribe to the constraint data sources 514 to receive updates on information for the external constraint data 516 used by the contextual constraints 506 of the routes 226, and may receive an updates including changed data for a subscribed external constraint data 516 element.

At operation 804, the ride-sharing server 208 identifies any affected routes 226. In an example, the ride-sharing server 208 may identify which routes 226 may be disturbed by the change in external constraint data 516. For instance, if a sports game time for the day is delayed, then routes 226 specified to transport users to the stadium for the game may need to be delayed. This may be possible, for example, because the ride-sharing server 208 may maintain route 226 information for the users that may be otherwise unavailable when vehicles 102 are typically rented.

At operation 806, the ride-sharing server 208 determines alternate routes 226. In an example, the ride-sharing server 208 may generate a new route 226, similar as discussed above with respect to generation of the route 226 described above with respect to operation 714.

At operation 808, the ride-sharing server 208 sends updates to affected riders of vehicles 102 scheduled to traverse the affected routes 226. In an example, the ride-sharing server 208 may send messages to the affected ride-sharing users indicating the proposed updated routes 226. After operation 808, the process 800 ends.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a computing device configured to
receive an indication of a change in constraint data, the change altering a vehicle-external factor used to determine at least one of a time, cost, intermediate waypoint, origin, and destination constraint of an upcoming user route;
determine an alternate route for the user in accordance with the constraint, as altered; and
send an update to a mobile device of the user indicating the alternate route.

2. The system of claim 1, wherein the computing device is a ride-sharing server configured to maintain the upcoming user route.

3. The system of claim 1, wherein the computing device is further configured to:
subscribe to an external data source configured to provide the constraint data to the computing device; and
receive the indication of a change in constraint data from the external data source in accordance with the subscription.

4. The system of claim 1, wherein the computing device is further configured to:
periodically poll an external data source configured to provide the constraint data to the computing device; and
receive the indication of a change in constraint data in accordance with the polling of the external data source.

5. The system of claim 1, wherein the change in constraint data includes a change in a time of an event to which the user is destined.

6. The system of claim 1, wherein the computing device is further configured to:
utilize a grammar to parse contextual information received from the user to identify a contextual constraint specifying the constraint data and a value against which the constraint data is to be tested;
identify a data source providing the constraint data; and
evaluate the contextual constraint based on the constraint data received from the data source.

7. The system of claim 6, wherein the data source includes at least one of a weather service, a traffic service, and an event calendar service.

8. The system of claim 6, wherein the route is further constructed according to a cost constraint such that the cost constraint specifies a maximum cost to the user for traversing that route that takes precedence over the contextual constraint.

9. A computer-implemented method comprising:
receiving, from a user device, a contextual constraint specifying timing for a route according to an event external to a vehicle traversing the route;
constructing the route using trip characteristics including an origin location and a destination location that satisfies the timing; and
providing an updated route to the user device calculated in response to a received update in the timing of the event.

10. The method of claim 9, wherein the contextual constraint specifies the timing as a time at which an outside temperature reaches a specified temperature.

11. The method of claim 9, wherein the contextual constraint specifies the timing as an arrival time at which an event is scheduled to take place, such that the vehicle is unavailable for ride-sharing during the event.

12. The method of claim 9, wherein the contextual constraint specifies a preferred characteristic for the route, and the trip characteristics specify mandatory characteristics for the route overriding the preferred characteristic.

13. The method of claim 9, further comprising maintaining the route by a ride-sharing server until the route is completed.

14. The method of claim 13, further comprising:
subscribing, by the ride-sharing server, to an external data source configured to provide scheduling information indicative of the timing of the event; and
receiving the indication of a change in external constraint data in accordance with the subscription to the external data source.

15. The method of claim 13, further comprising:
periodically polling, by the ride-sharing server, an external data source configured to provide scheduling information indicative of the timing of the event; and
receiving the indication of a change in external constraint data in accordance with the polling of the external data source.

16. The method of claim 9, wherein the received update includes a change in a time of an event to which the user is destined.

17. A system comprising:
a mobile device of a user configured to:
receive, from the user, a contextual constraint specifying an element of external constraint data to be tested and a value against which the element is to be tested;
display, to the user, a route constructed satisfying the contextual constraint based on the external constraint data; and
in response to a change in the external constraint data, display a received message indicating a proposed update to the route.

18. The system of claim 17, wherein the mobile device is further configured to:
receive speech input from the user;
transcribe the speech input into text; and
utilize a language grammar to parse the text into the contextual constraint.

19. The system of claim 17, wherein the mobile device is further configured to:
receive a language preference from the user; and
present the message in accordance with the language preference.

20. The system of claim 17, wherein the mobile device is further configured to display a user interface for user entry of the contextual constraint.

21. The system of claim 17, wherein the route is further constructed according to a cost constraint such that the cost constraint specifies a maximum cost to the user for traversing that route that takes precedence over the contextual constraint.
